(19) United States
(12) Patent Application Publication
(10) Pub. No.: US 2006/0104240 A1
(43) Pub. Date: May 18, 2006

(54) Trigger for sending scheduling information in HSUPA

(76) Inventors: Benoist Sebire, Beijing (CN); Esa Malkamaki, Espoo (FI); Karri Ranta-Aho, Espoo (FI)

Correspondence Address: WARE FRESSOLA VAN DER SLUYS &;ADOLPHSON, LLP, BRADFORD GREEN BUILDING 5, 755 MAIN STREET, P O BOX 224, MONROE, CT, 06468, US

(21) Appl. No.: 11/256,208

(22) Filed: Oct. 20, 2005

Related U.S. Application Data
(60) Provisional application No. 60/627,747, filed on Nov. 12, 2004.

(51) Int. Cl. H04Q 7/00

(52) U.S. Cl. 370/329

(57) ABSTRACT

A method and corresponding equipment by which a service access point (SAP) of a radio access network is able to trigger a user equipment (UE) terminal to send scheduling information to the SAP for use by the SAP in scheduling/allocating resources for packet uplink from the UE to the SAP. The method uses an AG (absolute grant) or RG (relative grant) rate control/scheduling message as the trigger. The scheduling information is then sent by the UE via a MAC-e (medium access control-extended) PDU (protocol data unit).

### CROSS REFERENCE To RELATED APPLICATION

Reference is made to and priority claimed from U.S. provisional application Ser. No. 60/627,747, filed Nov. 12, 2004.

### BACKGROUND OF THE INVENTION

1. Technical Field

The present invention pertains to the field of cellular communication. More particularly, the present invention pertains to wireless communication of packet data.

2. Discussion of Related Art

The UMTS (Universal Mobile Telecommunications System) uses a so-called DCH (dedicated channel, i.e. a logical channel allocate to an individual user), to which enhancements are currently being considered for packet communication in which some of the packet scheduler functionality is distributed to the Node-Bs—i.e. the wireless terminal components of a radio access network of UMTS, sometimes called here service access points (SAPs) or base stations—so as to have faster scheduling of bursty non real-time traffic than the layer 3 in the RNC (radio network controller of UMTS) can provide. Such an enhanced DCH is hereafter referred to as EDCH, and is intended for communication of packet data in release 6 of 3GPP (Third Generation Partnership Program). The idea is that with faster link adaptation it is possible to more efficiently share the uplink power resource between packet data users: when packets have been transmitted from one user, the scheduled resource can immediately be made available to another user.

These enhancements are being considered as part of the so-called HSUPA (high speed uplink packet access) effort to improve packet data rates used by 3G W-CDMA (wideband code division multiple access) user equipment in uplinking packets to an UMTS RAN, complementing work being done to improve downlink speeds (from the RAN to a UE), as part of the HSDPA (high speed downlink packet access) effort.

In the current architecture, the packet scheduler is located in the RNC and therefore is limited in its ability to rapidly adapt to changing traffic because of bandwidth constraints on the RRC signalling interface between the RNC and a UE (user equipment) terminal such as a mobile phone or other wireless terminal, sometimes called here simply a UE. Hence, to accommodate the variability in the traffic, the packet scheduler must be conservative in allocating uplink power so as to account for the influence of inactive users in the next scheduling period; having such a conservative packet scheduler turns out to be spectrally inefficient for high allocated data-rates and long release timer values.

With EDCH, much of the packet scheduler functionality is transferred to the Node-B, i.e. there is a Node-B scheduler that takes care of allocating uplink resources. For transmission of data, the UE selects a TFC (transport format combination) that suits the amount of data to be transmitted in its RLC (radio link control) buffer, subject to constraints on the maximum transmission power of the UE and the maximum allowed TFC (or, in effect, the maximum allowed data rate) or maximum allowed power. If needed, a UE can request a higher bit rate by sending so-called Rate (change) Request (RR) messages in the uplink, and the Node-B can then decide whether or not to grant a rate change (up or down) and then answer the UE with a rate grant message in the downlink. The rate grant messages can be either of two kinds: a Relative Grant (RG) or an Absolute Grant (AG). An RG indicates a rate value relative to the value in use by the UE (for either power or data rate). An UP command means that the UE is allowed to use more resource than previously, whereas a down command orders the UE to decrease its resource usage (power or data rate). An AG allocates resources to the UE in an absolute manner, in terms of data rate or power. Further, a null response by the Node-B, i.e. no transmission of either an RG or an AG, is understood by the UE to signal HOLD, i.e. do not either increase or decrease resource usage.

When to use AG or RG to adjust the resources allocated to the UE is decided by the RAN or by the so-called core network of UMTS (coupled to the UE via the RAN).

An AG or an RG message is transmitted in the downlink using specific physical channels designed for this purpose, namely E-AGCH (enhanced AG channel) and E-RGCH (enhanced RG channel).

For efficient Node-B scheduling, more information than simple RR messages is required from the UE. For instance it is useful for the Node-B to know the UE buffer status (e.g. how full it is) from reports to the Node-B by the UE, or the UE power status (e.g. how much power is left), or even some priority information regarding MAC-d flows or logical channels being used. Such scheduling information cannot be fit in the one-bit or two-bit RR message, and it has been proposed that such scheduling information be carried over a so-called MAC-e (media access control-enhanced) control PDU (protocol data unit) in the uplink. (The MAC (layer) provides a medium-independent interface to the so-called physical layer (PHY) of a layered communication protocol.)

A MAC-e data PDU contains data being exchanged between peer MAC-e entities—one in the RAN (and more specifically, in a Node-B) and one in a UE. There can be two kinds of MAC-e PDU: a control PDU and a data PDU. The MAC-e data PDU contains data coming from or being forwarded to the layer above MAC-e. The MAC-e control PDU contains data for operating the MAC-e layer: control information that is not usually forwarded to upper layers. Because the scheduling information is not targeted to upper layers and should be used by the Node-B scheduler in MAC-e only, it is logical to carry it over a MAC-e control PDU.

A problem to solve is how to trigger the sending of the MAC-e control PDU. For instance when the network asks the UE to send a MAC-e control PDU, which channel should the request go through? Is a new DL channel needed in addition to AG/RG? Do we have to use a signalling radio bearer and first report from MAC-e to the RRC (radio resource control) layer and then go back down to the UE?

The prior art teaches periodic and event-triggered reporting: a UE is configured to periodically report measurements (typically every few ms), or when certain criteria in the measured quantity are fulfilled, e.g. when the measured value exceeds a set reporting threshold. But the prior art does not teach how a Node-B is to trigger a UE to send scheduling information when the Node-B determines it would be useful to have such information.

### DISCLOSURE OF INVENTION

Accordingly, in a first aspect of the invention, a method is provided, comprising: a SAP (service access point) of a RAN (radio access network) transmitting a rate control message; and a UE (user equipment) terminal responding to the rate control message by transmitting at least some scheduling information to the SAP according to a predetermined rule for responding to receiving the rate control message. The transmitting of the rate control message is thus used by the SAP to trigger having the UE send (at least some) scheduling information to the SAP. The rate control message may be sent to the UE either in response to a rate (change) request by the UE, or independent of any such request.

In accord with the first aspect of the invention, the at least some scheduling information may be conveyed via a MAC-e (medium access control-enhanced) PDU (protocol data unit).

Also in accord with the first aspect of the invention, the rate control message may be an AG (absolute grant) or a RG (relative grant) type of rate control message.

Also in accord with the first aspect of the invention, the UE may be configured to respond to the rate control message independent of the content of the message, or may respond differently, depending on the content.

The invention also provides a SAP and a UE both operable according to the first aspect of the invention, as well as a corresponding system including a SAP and a UE.

### BRIEF DESCRIPTION OF THE DRAWINGS

The above and other objects, features and advantages of the invention will become apparent from a consideration of the subsequent detailed description presented in connection with accompanying drawings, in which:

FIG. 1 is a block diagram/flow diagram of a UE device and a SAP/Node-B of a RAN communicating control and scheduling information using signaling according to the invention.

FIG. 2 is a flow chart indicating in more detail the signalling indicated in FIG. 1.

### BEST MODE FOR CARRYING OUT THE INVENTION

The invention uses signaling of either of the two EDCH (enhanced dedicated channel) rate control/scheduling messages—the AG and RG messages—as a trigger by a Node-B/SAP (service access point) for prompting a UE (user equipment) terminal to transmit to the Node-B a MAC-e (medium access control-enhanced) control PDU (protocol data unit) carrying scheduling information. According to the invention, whenever a UE receives from a RAN entity (e.g. a Node-B/SAP) an EDCH scheduling message (other than ‘HOLD’ meaning do not change resource usage), whether the scheduling message is RG=UP/DOWN or AG=anything, the EDCH scheduling message triggers the UE to transmit to the RAN entity a MAC-e control PDU carrying scheduling information.

In some embodiments, the MAC-e control PDU transmitted by the UE contains different information depending on which EDCH scheduling message served as a trigger: if the MAC-e control PDU is triggered by an RG scheduling message, then it would contain one kind of information, but another kind if it is triggered by an AG scheduling message.

In some embodiments, a special value of AG is used to trigger different actions by a UE. For example, an AG equal to the current allocated maximum (power or TFC/data rate) can be used to signal “keep the current absolute grant.” An AG equal to the current rate used by the UE (power or TFC) can be used to signal “keep the current data rate.” An AG equal to a fixed bit value (some predetermined, reserved value) can be used to signal to the UE to send a MAC-e control PDU conveying scheduling information. For instance if three bits are used in the AG to allocate resources (power or TFC), a bit pattern of 111 could be reserved for asking a UE to transmit back to the SAP a MAC-e control PDU. Alternatively, more than one pattern could be reserved: e.g. one pattern for reporting buffer status and another one for reporting the power status. Finally, a particular bit of an AG message can be used to signal to a UE to transmit a MAC-e PDU by setting the bit. For example, if three bits are used to indicate the amount of resources allocated, the fourth bit could be used to indicate whether the SAP/Node-B wants the UE to transmit the MAC-e control PDU.

In case of using an RG message to trigger the UE to send (at least some) scheduling information via a MAC-e PDU, in some embodiments whenever an RG message (up or down command) is sent (thus changing the allocated resources), the UE reports a MAC-e control PDU containing scheduling information (regardless of whether the RG signals an increase or decrease in the rate. Such use of the RG would be especially advantageous for asking for a report of the power status of the UE. It could also be used—but perhaps less advantageously so—to request reporting the status of the buffer holding the packets to be transmitted and possibly retransmitted.

Also, the two methods—AG and RG signalling—can of course be used together, with for instance the RG method only taking care of having the UE report power status. In such embodiments, the SAP may send both an AG and an RG.

According to the invention, the UE sends a MAC-e control PDU bearing at least some scheduling information in the next or a subsequent (i.e. not necessarily the very next) uplink TTI (transmission time interval—i.e. the periodicity at which a Transport Block Set is transferred by the physical layer on the radio interface) whenever it receives an AG or RG rate control/scheduling message, and, in case of embodiments such as the above-described where scheduling information is sent only if a specific reporting command within the AG message in a form of a pre-determined bit-sequence or specific bit allocated for this purpose instructs the UE to do so, when the AG message includes such a reporting command. However, exactly how a UE responds, i.e. what scheduling information it reports, may depend on the content of the AG or RG signal (and more likely, the AG signal). (The MAC-e control PDU may not be sent in the very next TTI because the UE may need some time to process the request and thus may not be able to send the report immediately, i.e. in the very next TTI. Also if the next TTI is supposed to send a re-transmission of a previously sent and NACK'd packet, then the MAC-e control PDU cannot be sent in that TTI.)

Although in the above description the scheduling information is transmitted in a MAC-e control PDU, the invention also encompasses sending the scheduling information in the header of a MAC-e data PDU, and thus any kind of MAC-e PDU or other appropriate mechanism. It is the triggering action for causing a UE to send scheduling information that is provided by the invention, not any particular mechanism by which the UE transmits the requested scheduling information.

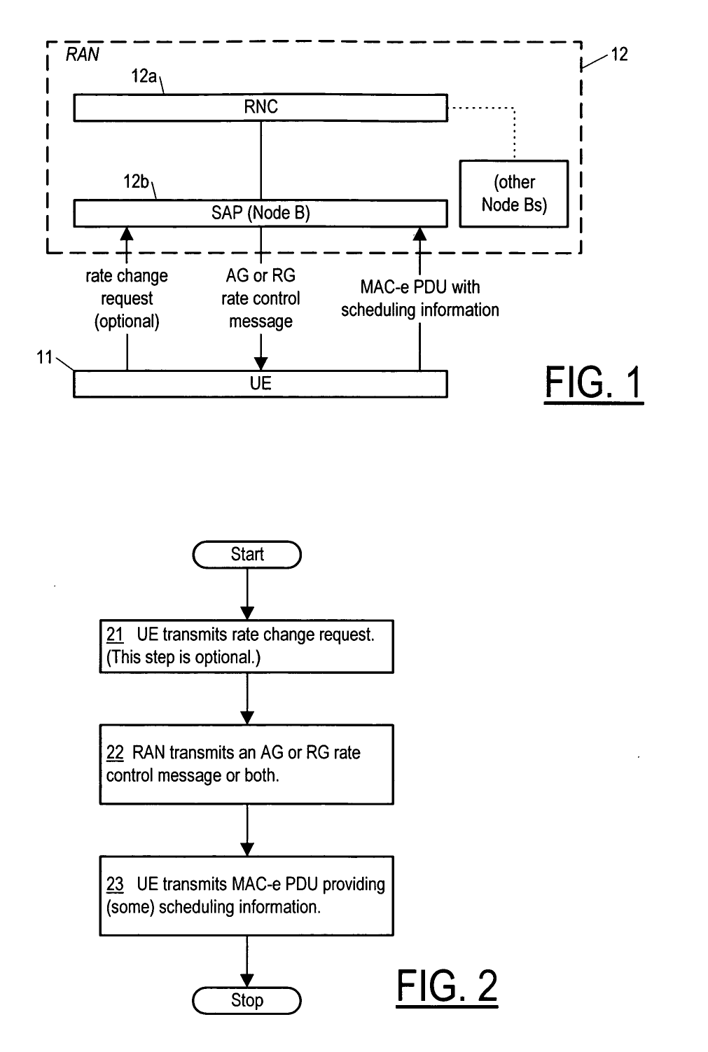

Thus, and now referring to FIGS. 1 and 2, according to the invention, in a step 21, a UE 11 transmits a rate change request to a SAP 12b of a RAN 12, which also includes a RNC 12a controlling the SAP in some respects. In a next step 22, the SAP transmits either an AG or an RG rate control/scheduling message or both, i.e. with what is here called a rate control message. The rate control message indicates a response to the rate change request, but also serves as a trigger for causing the UE to send a MAC-e PDU bearing scheduling information, i.e. is provided by the SAP to the UE according to a predetermined rule that the UE is to provide at least some scheduling information upon receiving the rate control message (and the scheduling information may depend on the content of the rate control message). Note though that the invention encompasses also having the SAP send to a UE a rate control message (either an AG or a RG message or both) even without the SAP having first received a rate change request from the UE. In some such embodiments, the rate control message may be a pure trigger, i.e. it may cause the UE to send scheduling information but not to adjust the rate in use. In a next step 23, the UE transmits to the SAP a MAC-e PDU providing at least some scheduling information for use by the SAP in scheduling/allocating uplink resources to the UE and to other UEs being served by the SAP. The transmitting of scheduling information to the UE is, according to the invention, a predetermined response to receiving a rate control message, and, as explained above, may depend on the actual content of the message, i.e. the bit values of the AG or RG message (or both).

It is to be understood that the above-described arrangements are only illustrative of the application of the principles of the present invention. Numerous modifications and alternative arrangements may be devised by those skilled in the art without departing from the scope of the present invention, and the appended claims are intended to cover such modifications and arrangements.

What is claimed is:

1. A method, comprising:
a service access point of a radio access network transmitting a rate control message; and
a user equipment terminal responding to the rate control message by transmitting at least some scheduling information to the service access point according to a predetermined rule for responding to receiving the rate control message.

2. A method as in claim 1, wherein the at least some scheduling information is conveyed via a MAC-e protocol data unit.

3. A method as in claim 1, wherein if the rate control message is an absolute grant message, then the user equipment terminal transmits different scheduling information than if the rate control message is an RG message.

4. A method as in claim 1, wherein different bit patterns of a bit signaled as the rate control message trigger the user equipment terminal to transmit different scheduling information.

5. A method as in claim 1, wherein the rate control message is a relative grant message and triggers the user equipment terminal sending power status as the at least some scheduling information.

6. A method as in claim 1, wherein the rate control message is an absolute grant message and triggers the user equipment terminal sending the at least some scheduling information.

7. A method as in claim 1, wherein the rate control message is an absolute grant message and triggers the user equipment terminal sending the at least some scheduling information but only if a predetermined bit of the absolute grant message is set.

8. A method as in claim 1, wherein the rate control message is an absolute grant message and triggers the user equipment terminal sending the at least some scheduling information but only if a predetermined bit-pattern is present in the absolute grant message.

9. A method as in claim 1, wherein the rate control message is an absolute grant message and triggers the user equipment terminal sending a buffer status as the at least some scheduling information.

10. A computer program product comprising a computer readable storage structure embodying computer program code thereon for execution by a computer processor, wherein said computer program code comprises instructions for performing a method according to claim 1.

11. A user equipment terminal apparatus, comprising:
means for receiving a rate control message; and
means for transmitting at least some scheduling information in response to receiving the rate control message according to a predetermined rule for responding to receiving the rate control message.

12. A service access point apparatus, comprising:
means for preparing a rate control message according to a predetermined rule relating the rate control message to at least some scheduling information to be provided by a user equipment terminal and for transmitting the rate control message to the user equipment terminal; and
means for receiving the at least some scheduling information from the UE provided in response to the user equipment terminal receiving the rate control message.

13. A system, comprising:
a service access point apparatus having means for transmitting a rate control message to a user equipment terminal according to a predetermined rule for indicating that the user equipment terminal is to provide at least some scheduling information upon receiving the rate control message; and
the user equipment terminal, having means for transmitting the at least some scheduling information in response to receiving the rate control message according to the predetermined rule.

14. A system as in claim 13, wherein the at least some scheduling information is conveyed via a MAC-e protocol data unit.

15. A system as in claim 13, wherein if the rate control message is an absolute grant message, then the user equipment terminal transmits different scheduling information than if the rate control message is a relative grant message.

16. A system as in claim 13, wherein different bit patterns of a bit signaled as the rate control message trigger the user equipment terminal to transmit different scheduling information.

17. A system as in claim 13, wherein the rate control message is a relative grant message and triggers the user equipment terminal sending power status as the at least some scheduling information.

18. A system as in claim 13, wherein the rate control message is an absolute grant message and triggers the user equipment terminal sending the at least some scheduling information.

19. A system as in claim 13, wherein the rate control message is an absolute grant message and triggers the user equipment terminal sending the at least some scheduling information but only if a predetermined bit of the absolute grant message is set.

20. A system as in claim 13, wherein the rate control message is an absolute grant message and triggers the user equipment terminal sending the at least some scheduling information but only if a predetermined bit-pattern is present in the absolute grant message.

21. A system as in claim 13, wherein the rate control message is an absolute grant message and triggers the user equipment terminal sending a buffer status as the at least some scheduling information.
